(19) United States
(12) Patent Application Publication
(10) Pub. No.: US 2001/0004433 A1
(43) Pub. Date: Jun. 21, 2001

(54) Structure for connection between elements of a bicycle frame, and process for making the said structure

(76) Inventor: Massimo Panzeri, Milan (IT)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/735,659

(22) Filed: Dec. 14, 2000

(30) Foreign Application Priority Data
Dec. 17, 1999 (IT) MI99A002630

(51) Int. Cl. B25G 3/34; F16B 11/00; F16B 12/04; F16L 13/00

(52) U.S. Cl. 403/268

(57) ABSTRACT

A connection structure for connecting elements of a frame, in which at least one first tubular element (16) is welded to a second tubular element (18), comprises a core (32) made of a material that is injectable in fluid form and is able to solidify expanding so as to adhere to appropriate surfaces for containing the material which belong to the tubular elements (16, 18). The connection structure is made by means of a process which comprises a step in which, inside the first tubular element (16) and at its end adjacent to the second element (18) to be joined, a material (34) in fluid form is introduced, and a step in which the material (34) solidifies, thus generating the core (32), which is rigid and adheres to the first tubular element (16) and to the second element (18).

The subject of the present invention is a structure for connecting elements of a frame of a bicycle and a process for making the said connection structure.

In what follows particular reference will be made to bicycles built of light material, such as aluminium. It is, however, evident that a structure similar to the one that will be described can be adopted for bicycles built of any material whatsoever.

As is known, in order to contribute to improving the performance of athletes, competition bicycles have been built, for a long time now, using very light materials. Among these materials, an extensively used one is aluminium on account of its characteristics of resistance, lightness, contained cost, and good workability.

The use of such materials has become very widespread, and it is by now a common practice to build also the frames of trekking bicycles or coasting bicycles of aluminium.

Bicycle frames are usually made of tubular elements joined together by welding. In particular, the frame comprises a seat tube, connected to which is one end of a top tube, which is substantially horizontal.

The top tube has another end which is fixed to a head tube to which also a down tube is fixed. The down tube and the seat tube are then both fixed to a crank-case which supports the crank-arms or pedal crank.

According to the usual manufacturing techniques, the above connections are generally made by means of weld beads.

However, notwithstanding the considerable advantages, especially in terms of lightness, that are obtained when frames are made of aluminium, in certain cases serious problems may arise that are linked to the resistance of the connections between the various tubular elements.

In fact it has been found that, particularly in the area corresponding to the connection between the seat tube and the crank-case, failures may occur or cracks may form that weaken the resistance of the connection. This is due to the fact that the connection between the seat tube and the crank-case is subject to very intense stresses, both of a static nature and ones due to fatigue.

In particular, fatigue stresses, which are caused by pedal strokes on the part of the cyclist, are particularly intense when the bicycle is used in a competition context.

It is in fact evident that in this case the intensity and frequency of the stresses is higher than when the bicycle is used in a non-competition context.

It is moreover evident that, in the case of failure, the cyclist may fall off the bicycle and get hurt, even very seriously.

A purpose of the present invention is therefore to eliminate the technical drawbacks referred to above by making a structure of connection between elements of a bicycle frame that will have a very long duration even in the presence of stresses of very high intensity and/or frequency.

Another purpose of the invention is to make a structure of connection between elements of a bicycle frame that is very light so as not to render the bicycle frame too heavy.

A further purpose of the invention is to provide a structure of connection between elements of a bicycle frame that can be assembled in a simple, fast and economic way.

Yet another purpose of the invention is to make a structure of connection between elements of a bicycle frame that renders the bicycle itself very safe.

An additional purpose of the invention is to provide a process for creating such a structure of connection between elements of a bicycle frame.

These and other purposes according to the present invention are achieved by creating a structure of connection between elements of a bicycle frame according to claim 1.

The said structure is advantageously obtained by means of a process according to claim 4.

Other characteristics of the structure and of the process according to the invention are moreover specified in the other claims attached hereto.

Advantageously, the connection structure according to the present invention makes it possible to make up for any defects in the weld beads, so that the product will always have a very high standard of quality.

Further characteristics and advantages of a structure of connection between elements of a bicycle frame and of a process for making the said structure according to the present invention will emerge more clearly evident from the ensuing description, which is given purely to provide a non-limiting example, with reference to the attached schematic drawings, in which:

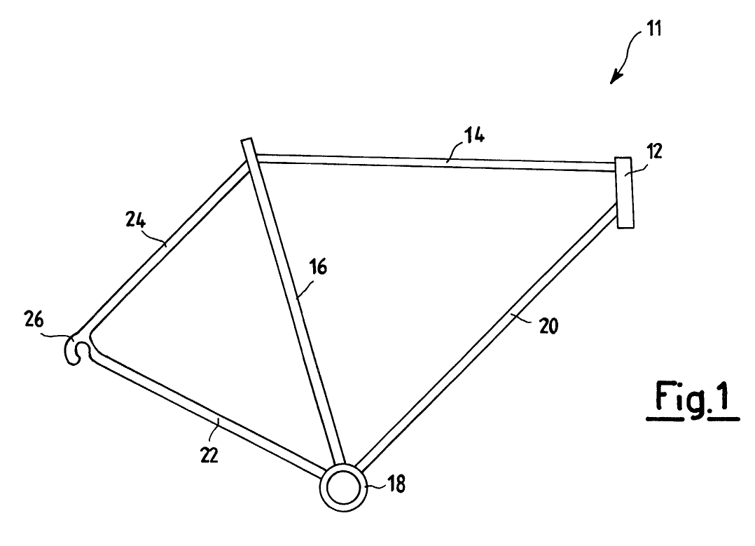

FIG. 1 is a schematic representation of a bicycle frame;

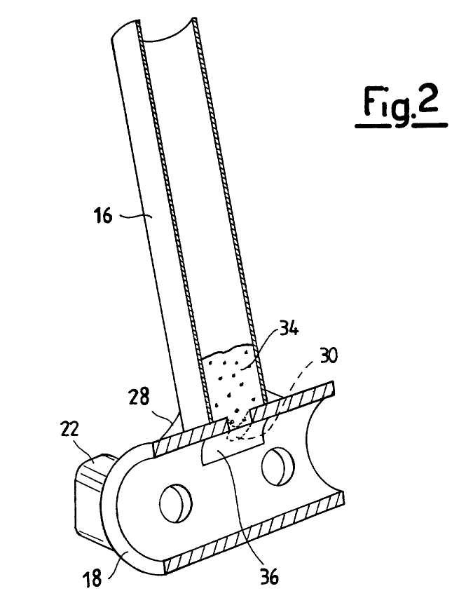

FIG. 2 is a perspective cross-sectional view of a crank-case supporting a crank fixed to a seat tube, with a material non yet solidified inserted into it; and

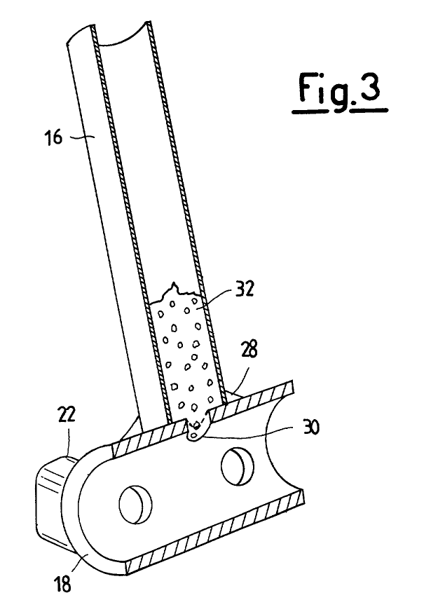

FIG. 3 is a perspective cross section of the elements shown in FIG. 2, with the material already solidified, so as to form a core of resistance adherent to the crank-case and to the seat tube.

With reference to the above-mentioned figures, a structure of connection between the elements of a bicycle frame is illustrated, the frame as a whole being designated by the reference number 11.

The frame 11 comprises a head tube 12 in which the handlebars (not shown) are inserted. One end of a top tube 14 is fixed to the head tube 12, whilst another end of the top tube 14 is fixed to a seat tube 16.

The seat tube 16, in turn, has one end fixed to a crank-case 18 of a pedal crank (not shown), whilst a seat (not shown) is connected to the other end.

Fixed to the crank-case 18 are also both one end of a down tube 20, which has its opposite end fixed to the head tube 12, and the elements of a first fork 22. The first fork 22 has one free end which is fixed to a second fork 24. At the joined tips of the forks 22, 24, the frame 11 has housings 26 in which an axle of a rear wheel (not shown) of the bicycle is inserted.

All the connections between the elements making up the frame 11, and in particular the connection between the crank-case 18 and the seat tube 16, are obtained by means of weld beads 28 which are made on the outside of the elements 12, 14, 16, 18, 20, 22, and 24.

The crank-case 18 moreover has a through hole 30 which opens inside the seat tube 16. The end part of the seat tube 16 is completely filled with a core 32 which in fact extends inside the seat tube 16 and which contributes to improving the connection between the seat tube 16 itself and the crank-case 18.

The core 32 consists of a material that can be injected in fluid form and is able to solidify expanding so as to adhere to appropriate containment surfaces which belong to the tubular elements 16 and 18.

In particular, the said core 32 may consist of a structural reinforcing material, such as the product Terocore 1011 (a Henkel registered trade mark).

The structural reinforcing product Terocore 1011 has a very low specific weight, so that the weight of the bicycle will not increase appreciably after the said product has been injected, and is able to adhere very firmly to the metal walls, whether these are rough or painted.

In addition, Terocore 1011 has a very high section modulus, which has made possible a considerable diffusion of the said product in order to increase the performance of metal structures designed to withstand stress, impact or compressive stresses.

Instead, it has been unexpectedly noted that, although the usual uses of Terocore 1011 have been directed to a very different type of stresses compared to the ones that occur in the connection between the crank-case 18 and the seat tube 16 of a bicycle, its injection between the crank-case 18 and the seat tube 16 even so enables a considerable increase in the life of the frame 11.

As regards fatigue resistance, it has in fact been found that the life of bicycle frames 11 provided with the Terocore 1011 core 32 is usually doubled.

The core 32 also enables an unexpected increase in resistance to shear, bending and torsional stresses. The structure of connection between elements of a bicycle frame according to the present invention may be assembled according to the process indicated in what follows.

The preliminary step is to assemble the bicycle in a similar way as the one adopted for traditional bicycles.

Next, the frame 11 of the bicycle is painted, and after the paint has dried the next step is to form the core 32 inside the seat tube 16 as described below.

When the paint has dried, a thin straw-like tube (not shown) is introduced into the crank-case 18 and is made to pass through the hole 30 until it also enters the inside of the seat tube 16.

A fluid material, such as Terocore 1011, is then injected through the aforesaid thin tube and, after the hole 30 has been obstructed with adhesive tape 36 to prevent loss of the material (which, when it is still in the fluid state, is indicated by the reference number 34), the said fluid material is left to solidify, for example by polymerization at room temperature for approximately 24 hours without any further intervention.

Following upon solidification, the material 34 increases in volume and generates the rigid core 32, which adheres perfectly to the walls of the seat tube 16 and of the crank-case 18.

It has in practice been noted that the structure of connection between elements of a bicycle frame and the process for obtaining the said structure according to the invention are particularly advantageous because they are both very simple and economic. In addition, the structure may be assembled in a very simple way and is not rendered heavy.

The connecting structure between a bicycle frame and the process for achieving the said structure, as conceived herein, may undergo numerous modifications and variations, all falling within the scope of the invention. In addition, all the items may be replaced by technically equivalent elements.

In practice, the materials used, as well as the various dimensions, may be any whatsoever according to the technical needs.

1. A connection structure for connecting elements of a bicycle frame, in which at least one first tubular element (16) is welded to a second tubular element (18), characterized in that it comprises a core (32) made of a material that is injectable in fluid form and is able to solidify expanding so as to adhere to appropriate surfaces for containing the aforesaid material which belong to said tubular elements (16, 18):

2. A connection structure according to claim 1, characterized in that the above-mentioned second element (18) has at least one through hole (30) that opens inside said first tubular element (16) to enable insertion of said material in fluid form.

3. A connection structure according to claim 1, characterized in that the aforesaid first tubular element (16) consists of a seat tube of the frame (11) of said bicycle, and the aforesaid second element (18) consists of a crank-case of a crank of said bicycle.

4. A process for building a structure of connection between elements of a bicycle frame, characterized in that it comprises: a step in which, inside a first tubular element (16) and at a point corresponding to one of its ends adjacent to a second element (18), which is in turn welded to said first element (16), a material (34) in fluid form is introduced; and a step in which the aforesaid material (34) solidifies expanding, thus generating a rigid core (32) which adheres to appropriate surfaces for containing the said material, which belong to said first tubular element (16) and to said second element (18).

5. A process according to claim 4, characterized in that the aforesaid material (34) is introduced inside said first tubular element (16) through at least one through hole (30) made in said second element (18), where said through hole (30) opens inside said first tubular element (16).

6. A process according to claim 5, characterized in that, after introduction of said material (34) inside said first tubular element (16), said through hole (30) is obstructed so as to prevent any leakage of the material still in fluid form.

7. A process according to claim 4, characterized in that said solidification phase is a polymerization phase that takes place at room temperature.

8. A process according to claim 7, characterized in that said polymerization phase has a duration of approximately 24 hours.

9. A process according to claim 4, characterized in that the aforesaid material (34) is Terocore 1011.
